(19) United States
(12) Patent Application Publication
(10) Pub. No.: US 2026/0249542 A1
(43) Pub. Date: Aug. 27, 2026

(54) METHOD AND FACILITY FOR DETERMINING A VALUE REPRESENTATIVE OF THE ABSORPTION COEFFICIENT OF A PREFORM

(71) Applicant: SIDEL PARTICIPATIONS, Octeville-sur-Mer (FR)

(72) Inventors: Guy FEUILLOLEY, OCTEVILLE-SUR-MER (FR); Nicolas LANGLOIS, OCTEVILLE-SUR-MER (FR); Mikael DERRIEN, OCTEVILLE-SUR-MER (FR)

(21) Appl. No.: 19/142,398

(22) PCT Filed: Dec. 6, 2023
(86) PCT No.: PCT/EP2023/084570

§ 371 Date: Jun. 23, 2025

(30) Foreign Application Priority Data
Dec. 26, 2022 (FR) FR2214488

(51) Int. Cl. B29C 49/78; G01N 21/59; G01N 21/84

(52) U.S. Cl. CPC B29C 49/78; G01N 21/59; B29C 2049/787; B29C 2049/78755; G01N 2021/845

(57) ABSTRACT

Provided is a method for determining a value representative of the absorption coefficient of a thermoplastic material constituting a preform, when the preform is transported in a facility for manufacturing containers by the shaping of preforms. The method includes measuring a value representative of the transmittance of infrared radiation through at least one wall of the preform during its movement; measuring the thickness of the wall of the preform during its movement; and calculating the value representative of the absorption coefficient of the plastics material independently of the thickness of the preform on the basis of the measurement of the value representative of the transmittance and of the measurement of the thickness.

### TECHNICAL FIELD OF THE INVENTION

The invention proposes a method for determining a value representing the absorption coefficient of a thermoplastic material forming a preform, when the preform is conveyed along a predetermined path in a facility for manufacturing containers by shaping preforms, as well as a facility able to implement this method.

### TECHNICAL BACKGROUND

It is known practice for containers to be manufactured by shaping, notably by stretch-blowing, preforms made of thermoplastic material. The material forming the preforms is generally in an amorphous state that is not able to allow the cold shaping thereof. Before the shaping operation, the preforms are therefore heated to a temperature that is greater than or equal to a glass transition temperature that allows them to be shaped as a final container.

More specifically, the preforms generally have a substantially rotationally cylindrical body with a thick tubular wall, one of the axial ends of which is closed by a thick-walled base, and the other end of which is extended by a neck, which is also tubular. The neck is shaped into its final shape and dimensions while the body of the preform is intended to undergo a relatively major deformation in order to shape it into a container during a shaping step.

For this reason, it is preferable for only the body of the preform to be heated beyond the glass transition temperature, with the neck remaining at a temperature below said glass transition temperature in order to prevent it from deforming while the container is being manufactured.

Furthermore, the temperature of the body also should not exceed a crystallization temperature that is greater than the glass transition temperature. Beyond this crystallization temperature, the thermoplastic material crystallizes and no longer has the mechanical properties for shaping to the required quality. It is important that the crystallization of the material is only induced, in a controlled manner, during the shaping operation so that the polymer chains are oriented in required directions.

The mass production of containers is carried out in a production facility in which the preforms run along a pre-determined production path. Each preform is supported by conveying means. Such conveying means can be formed by a rail conveyor, along which the preforms are free to come into contact with each other, or a conveyor that has components for gripping each preform individually.

The production facility has a heating station that allows, during a heating step, the body of the preform to be rendered malleable by heating beyond the glass transition temperature. During the heating step, each preform is exposed to heating radiation during its movement.

The production facility also comprises a shaping station that is arranged downstream of the heating station in the direction of flow of the preforms in the production facility. During the shaping step, the hot preform is placed in a shaping unit, for example, in a mold of the shaping station that has a molding imprint matching the container to be obtained. A pressurized fluid, such as air, is then injected into the malleable body of the preform in order to press the wall against the imprint of the mold. Generally, the injection of pressurized fluid is preceded and/or accompanied by axial stretching of the preform, notably by means of a stretching rod inserted into the preform. In a known manner, the body thus undergoes bi-axial stretching.

When passing through the heating station, each preform is generally exposed to infrared radiation that allows the thermoplastic material to be heated. The temperature at which the preforms are heated depends on the absorption factor (A) of the preform for the wavelengths of the infrared radiation. The absorption factor (A) is sometimes referred to as “absorptance”.

The absorption factor (A) is defined as being the ratio of the flux of absorbed heating radiation to the flux of incident heating radiation. The flux of absorbed heating radiation causes the temperature of the thermoplastic material forming the preform to increase. The absorption factor (A) of the preform thus allows the increase in temperature of a preform to be known as a function of the intensity of the infrared radiation and of the duration of exposure to said radiation. Less energy is required to heat a preform with a high absorption factor (A) compared to a preform with a lower absorption factor (A).

The absorption factor (A) can be derived from two other parameters, called the transmittance (T) of the preform, as well as its reflectance (R).

The transmittance (T) is defined as the ratio of the flux of heating radiation transmitted through at least one wall of the preform to the flux of incident heating radiation.

The reflectance (R) is defined as the ratio of the flux of heating radiation reflected by the preform to the flux of incident heating radiation. The reflectance (R) is computed, for example, as a function of the refractive index (n) of the thermoplastic material according to the following formula:

R=[(n−1)/(n+1)]²
in which the value of “1” corresponds to the refractive index of air.

These three factors depend on the wavelength of the considered radiation.

Since the preforms are heated by means of heating radiation in the near infrared band, the considered wavelength is taken in this band.

These three factors are related to each other by the following equation:

$$A = 1 - R - T$$

However, the obtained absorption factor mainly depends on two parameters. Firstly, the absorption factor depends on the absorption coefficient, sometimes called absorbance, of the thermoplastic material. The absorption coefficient is an intrinsic feature of the thermoplastic material that does not depend on the geometry of the preform. In addition, the absorption factor significantly depends on the geometry of the considered preform, and notably on its thickness.

Preforms belonging to the same batch are intended to be made with a thermoplastic material with the same features, and they are intended to have a wall with the same thickness. However, when an absorption factor value is determined for two preforms from the same batch, it is impossible to know which proportion of any defect originates from the geometry of the preform or from the composition of the thermoplastic material.

Production facilities are already known that are equipped with transmittance measurement devices that allow the transmittance of the preform to be measured by measuring the attenuation of an infrared signal with a defined wavelength, passing through two walls of the preform.

In these facilities only the transmittance is measured. No information is provided with respect to the measurement of the thickness of the preform. Thus, although some documents misuse the terms “absorbance” or “absorption coefficient”, they actually only allow the absorption factor of the analyzed preform to be obtained because none of these documents includes the thickness of the considered preforms.

In the existing solutions, this measurement allows the operating parameters of the furnace to be modified in order to adapt them to the absorption factor of the preforms.

However, the known facilities do not allow the preforms to be analyzed with sufficient precision to determine whether any production defects are due to the operation of the heating station, the geometry of the preforms or the composition of the thermoplastic material.

This problem is even more critical when the preforms are made with recycled plastic materials, such as recycled polyethylene terephthalate (rPET), which are inherently less homogeneous than virgin plastic materials.

Furthermore, it also can be worthwhile comparing the thermoplastic materials forming preforms with different batches or different formats in order to quickly identify possible quality problems related to a particular provider.

### SUMMARY OF THE INVENTION

The invention proposes a method for determining a value representing the absorption coefficient of a thermoplastic material forming a preform, when the preform is conveyed along a predetermined path in a facility for manufacturing containers by shaping preforms, the method being characterized in that it comprises:
a step of measuring a value representing the transmittance of infrared radiation through at least one wall of the preform during its movement along the path;

and
a step of measuring the thickness of said wall of said preform during its movement along the path;
a step of computing the value representing the absorption coefficient of the plastic material independent of the thickness of the preform based on said measurement of the value representing the transmittance and said measurement of the thickness.

According to another feature of the method carried out according to the teaching of the invention, the measurement of the value representing the transmittance and the measurement of the thickness are carried out at the same height of the wall of the preform.

According to another feature of the method carried out according to the teaching of the invention, the measurement of the value representing the transmittance and the measurement of the thickness are carried out at the same point on the wall of the preform.

According to another feature of the method carried out according to the teaching of the invention, the measurement of the value representing the transmittance and the measurement of the thickness are successively carried out in two distinct measurement zones of the production path.

According to another feature of the method carried out according to the teaching of the invention, the measurement of the value representing the transmittance and the measurement of the thickness are simultaneously carried out in the same measurement zone of the production path.

According to another feature of the method carried out according to the teaching of the invention, the measurement of the value representing the transmittance is carried out by measuring the attenuation of the intensity of a first monochromatic light beam after it passes through at least one wall of the preform, with the first light beam having a first predetermined wavelength and being emitted perpendicular to the wall of the preform.

According to another feature of the method carried out according to the teaching of the invention, the first predetermined wavelength is within the near infrared band, for example, between 800 and 1,600 nm.

According to another feature of the method carried out according to the teaching of the invention, the measurement of the thickness of the wall is carried out by means of a confocal measurement device that emits a second continuous spectrum light beam in a predetermined wavelength range.

According to another feature of the method carried out according to the teaching of the invention, the measurement of the thickness of the wall is carried out by an interferometric measurement device that emits a second continuous spectrum light beam in a predetermined wavelength range.

According to another feature of the method carried out according to the teaching of the invention, the first wavelength of the first light beam is outside the wavelength range of the second light beam.

According to another feature of the method carried out according to the teaching of the invention, the method is repeated for each preform passing through the one or more measurement zones.

The invention also relates to a facility for implementing the method carried out according to the teaching of the invention, the facility comprising means for conveying preforms in a line along a predetermined production path successively passing through a zone for heating a body of the preforms and through a station for shaping preforms into a container, notably by stretch-blowing, the facility comprising:
a device for measuring a value representing the transmittance of at least one wall of the preforms when they pass through an associated measurement zone;
a device for measuring the thickness of the wall of the preforms when they pass through an associated measurement zone.

According to another feature of the facility according to the teaching of the invention, the device for measuring a value representing the transmittance comprises a first light source that emits a first monochromatic light beam having a first wavelength, and the device for measuring thickness comprises a second light source, distinct from the first light source, that emits a second light beam as a continuous spectrum in a predetermined wavelength range.

According to another feature of the facility according to the teaching of the invention, the first light beam and the second light beam pass through the wall of the preform at the same height.

According to another feature of the facility according to the teaching of the invention, the first light beam and the second light beam pass through the wall of the preform at the same point.

According to another feature of the facility according to the teaching of the invention, the measurement of the value representing the transmittance and the measurement of the thickness are successively carried out in two distinct measurement zones of the production path.

According to another feature of the facility according to the teaching of the invention, the measurement of the value representing the transmittance and the measurement of the thickness are carried out simultaneously in the same measurement zone of the production path.

According to another feature of the facility according to the teaching of the invention, the first light source and the second light source are arranged on either side of the production path so as to emit the first light beam and the second light beam coaxially to each other.

According to another feature of the facility according to the teaching of the invention, the thickness measurement device comprises a spectrometer measuring the intensity and the wavelength of two portions of the second light beam respectively reflected by an outer face and by an inner face of the wall of the preform.

According to another feature of the facility according to the teaching of the invention, the device for measuring a value representing the transmittance comprises a component for measuring the intensity of the first light beam after it has passed through at least one wall of the preform.

According to another feature of the facility according to the teaching of the invention, the measurement component of the device for measuring a value representing the transmittance and the spectrometer of the thickness measurement device are formed by a single spectrometer common to both devices.

According to another feature of the facility according to the teaching of the invention, the first wavelength of the first light beam is outside the wavelength range of the second light beam.

According to another feature of the facility according to the teaching of the invention, the device for measuring the value representing the transmittance and the device for measuring the thickness are arranged along the production path upstream of the heating zone.

### BRIEF DESCRIPTION OF THE FIGURES

Further features and advantages of the invention will become apparent while reading the following detailed description, which is to be understood with reference to the appended drawings, which are briefly described below.

FIG. 1 is a top view that schematically shows a facility for manufacturing containers produced according to a first embodiment of the invention.

FIG. 2 is a side view that shows a preform intended to be processed by the facility of FIG. 1.

FIG. 3 is a block diagram that shows a method for implementing the facility of FIG. 1 in order to determine a value representing an absorption coefficient of a preform.

FIG. 4 is a block diagram that shows an alternative embodiment of the first embodiment of the method.

FIG. 5 is a vertical cross-sectional view in the sectional plane 5-5 of FIG. 1 that shows a device for measuring a transmittance of a preform.

FIG. 6 is a diagram that shows the intensity of a monochromatic light beam after it has passed through two wall thicknesses of the preform of FIG. 5.

FIG. 7 is a vertical cross-sectional view in the sectional plane 7-7 of FIG. 1 that shows a confocal measurement device for measuring the thickness of a wall of a preform.

FIG. 8 is a detailed view of FIG. 7 that schematically shows the reflected portions of a light beam emitted by the confocal measurement device of FIG. 7.

FIG. 9 is a diagram that shows the intensity of the reflected parts of the light beam emitted by the confocal measurement device of FIG. 7 according to their wavelength.

FIG. 10 is a view similar to that of FIG. 7 that shows an alternative embodiment in which the confocal measurement device is replaced by an interferometric measurement device.

FIG. 11 is a diagram that shows the intensity of the interference of the reflected parts of the light beam emitted by the interferometric measurement device of FIG. 7 according to their wavelength.

FIG. 12 is a diagram that shows the Fourier transform of the curve of FIG. 11.

FIG. 13 is a block diagram that shows a method for determining a value representing an absorption coefficient of a preform produced according to a second embodiment of the invention.

FIG. 14 is a top view similar to that of FIG. 1 that schematically shows a facility for manufacturing containers produced according to a second embodiment of the invention that is able to implement the method of FIG. 13.

FIG. 15 is a vertical cross-sectional view in the sectional plane 15-15 of FIG. 14 that shows a device for measuring the thickness of a wall of a preform as shown in FIG. 7 or in FIG. 10 combined with a transmittance measurement device as shown in FIG. 5.

FIG. 16 is a diagram that shows the light intensity of the beams transmitted and reflected by the device of FIG. 15 according to their wavelength, when the thickness measurement device is a confocal measurement device.

FIG. 17 is a diagram that shows the light intensity of the beams transmitted and reflected by the device of FIG. 15 according to their wavelength, when the thickness measurement device is an interferometric measurement device.

### DETAILED DESCRIPTION OF THE INVENTION

Throughout the remainder of the description, the terms “top”, “bottom”, and the derivative terms “high”, “low”, are used for the sake of clarity with reference to the orientation of the figures, yet without this having any limiting scope.

Throughout the remainder of the description, the wavelengths of the light radiation will be expressed in nanometers, indicated by the abbreviation “nm”.

In theory, a monochromatic source is an ideal source emitting a single frequency sine wave. In other words, its frequency spectrum is made up of a single line with a zero spectral width (Dirac).

In practice, such a source does not exist, an actual source with a frequency emission spectrum that extends over a band with a low but non-zero spectral width, for example, a few tens of nanometers, is centered on a main frequency where the intensity of the radiation is maximum.

Throughout the remainder of the description, such an actual source is considered to be monochromatic.

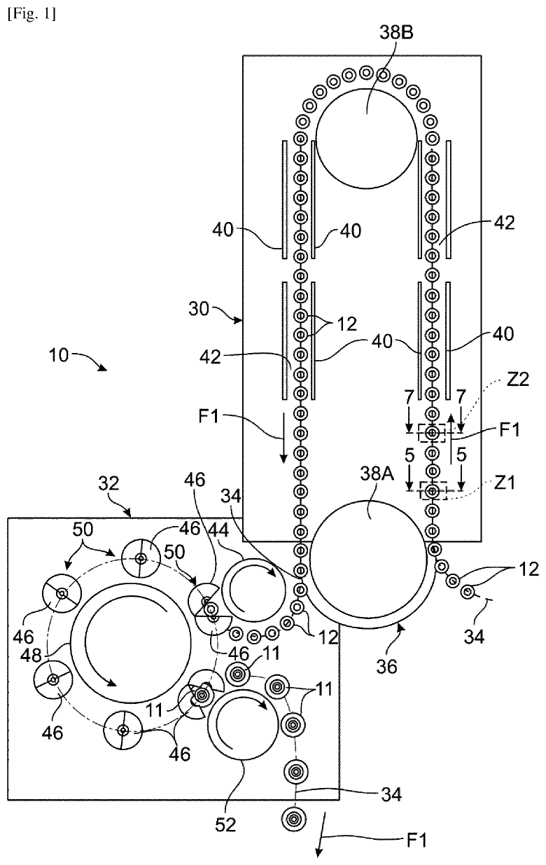

FIG. 1 schematically illustrates a facility 10 for manufacturing containers 11 from thermoplastic preforms 12 and more specifically made of PET (polyethylene terephthalate) or rPET (recycled polyethylene terephthalate). The thermoplastic material can optionally, but not necessarily, contain additives that artificially increase the absorption factor of the preform.

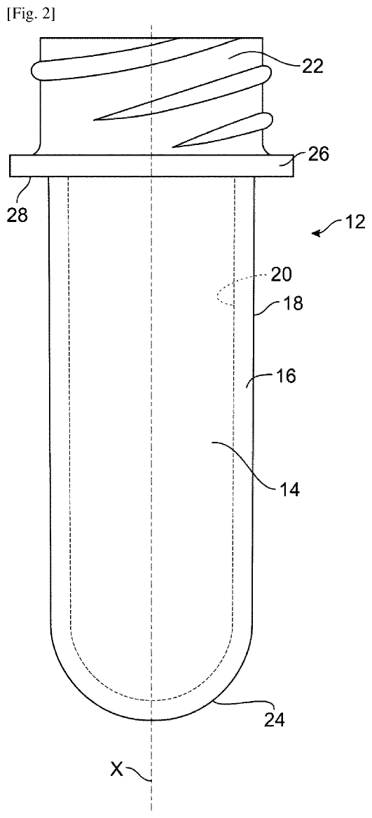

As shown in FIG. 2, each preform 12 comprises a cylindrical body 14 with an “X” axis. The body 14 comprises a transparent side wall 16 that defines an internal volume. The wall 16 has a rotational shape about the “X” axis so that at a given height, the wall 16 has a constant thickness. However, the thickness of the wall 16 is likely to vary as a function of the height. The wall 16 is delimited by an outer face 18 that is oriented toward the outside of the preform 12 and by an inner face 20 that faces the internal volume.

An upper end of the body 14 emerges through a neck 22. The neck 22 assumes the definitive shape of that of the container 11 to be obtained. As a result, the neck 22 does not experience any deformation while the container 11 is being manufactured. The body 14 comprises a base 24 that closes its lower end and that is generally hemispherical. The neck 22 comprises a collar 26 arranged at its junction with the body 14. The lower face of the collar 26 is intended to form a bearing surface 28 for supporting the preform 12 while it is molded and/or transported.

After being injection molded, the preforms 12 are suddenly cooled so that an amorphous state is imparted to the thermoplastic material. It is thus possible to make the thermoplastic material malleable once again by heating beyond a glass transition temperature.

With further reference to FIG. 1, the manufacturing facility 10 comprises a heating station 30 and a shaping station 32. The preforms 12 move in a line along a production path 34 that passes through the heating station 30 and the shaping station 32. The direction of travel of the preforms 12 is indicated by the arrows “F1” in FIG. 1. During normal operation of the manufacturing facility 10, the preforms 12 constantly move along the production path 34.

The manufacturing facility 10 generally comprises a device (not shown) for supplying preforms 12 that are rectified and aligned in a line.

The production path 34 starts from the moment the preforms 12 are rectified and aligned in a line. The preforms 12 notably can be individually supported by a conveyor or be received against each other in a line between guide rails, as is the case for the preforms 12 before they reach the heating station 30.

The purpose of the heating station 30 is to heat the body 14 of the preforms 12 to a temperature that is greater than or equal to the glass transition temperature of the constituent material, for example, greater than 70° C. when this material is PET. The heating station 30 comprises a conveyor 36 (schematically illustrated) for conveying the preforms 12 by rotating them on themselves.

The conveyor 36 generally comprises mandrels (not shown) that fit together with the neck 22 in order to convey the preforms 12. The mandrels move along a closed circuit. The mandrels are, for example, supported by the links of a chain or even by independent shuttles moving along a rail.

In this case, the circuit comprises two straight parallel sections connected by sections with 180° turns. The conveyor 36 further comprises two wheels 38A, 38B for guiding the mandrels in the turning portions of the closed circuit.

The heating station 30 also comprises heating means 40 for heating the preforms 12. This involves, for example, lamps facing reflectors or laser sources that emit heating electromagnetic radiation in the near infrared band that is within a wavelength range that ranges between 780 nm and 3,000 nm. The intensity of the heating electromagnetic radiation is notably higher in a higher intensity wavelength range that ranges between 800 nm and 1,600 nm.

The heating means 40 are arranged along a heating zone 42 of the path 34 for producing preforms. In the example shown in FIG. 1, the heating station 30 comprises a heating area 42 divided into two parts arranged upstream and downstream of the turning portion guided by the guide wheel 38B.

The preforms 12 entering the heating station 30 are individually supported by the conveyor 36 on which they follow a U-shaped section on their production path 34 passing through the heating zone 42. They are heated throughout the production run by the heating means 40, which, if necessary, are placed on one side or on either side of the preforms 12 with respect to their direction of travel. The hot preforms 12 are extracted from the heating station 30 after they pass through the heating zone 42 and are transferred into molds on the shaping station 32 by a first transfer device 44, such as a transfer wheel, interposed between the heating station 30 and the shaping station 32.

The transfer wheel comprises arms (not shown, as they are known per se) that successively grip the preforms 12, as they leave the heating station 30, in the vicinity of their neck 22, so that they are each in turn introduced into a mold 46 of the shaping station 32. The shaping station 32 comprises a rotating carousel 48, with a plurality of blowing stations 50 being disposed on the periphery of said carousel.

Each blowing station 50 comprises at least one mold 46 that defines a cavity with the impression of the container 11. Each blowing station 50 comprises means (not shown) for forming/deforming the body 14 of the preform 12 and pressing it against the imprint of the mold 46, for example, by stretch-blowing.

Each hot preform 12 exiting the heating station 30 is introduced into a mold 46 of the blowing station 50 to be blown therein and transformed into a container 11. Once completed, the container 11 is extracted from the blowing station 50 by a second transfer device 52 similar to the first transfer device 44.

In order to automatically and quickly analyze the quality of the preforms 12, the invention proposes a method for determining a value representing the absorption coefficient “a” of the thermoplastic material forming a preform 12 that is independent of the thickness “s” of the wall 16. This method is implemented when the preform 12 moves along the production path 34 in the facility 10 for manufacturing containers 11. Preferably, the preform 12 is constantly moving while the method is implemented.

In the examples shown in the figures, the method is implemented when the preforms 12 are conveyed by the conveyor 36 of the heating station 30. This conveyor 36 conveys the preforms 12 through the heating zone 42.

The method is preferably implemented on the preforms 12 before they are heated, therefore upstream of the heating zone 42. However, it also can be implemented on preforms 12 that are already hot, downstream of the heating zone 42.

As shown in FIG. 3, the method comprises a first step “E1” of measuring a value representing the transmittance “T” of infrared radiation through at least one wall 16 of the preform 12 during its movement along the production path 34.

The method further comprises a second step “E2” of measuring the thickness “s” of said wall 16 of said preform 12 during its movement along the production path 34.

The method then comprises a third step “E3” of computing the value representing the absorption coefficient “α” of the thermoplastic material independent of the thickness “s” of the preform 12 based on the measurement of the transmittance “T” and the thickness “s” that is carried out during the first two steps “E1, E2”. This third step “E3” of computing therefore obviously occurs after the first two steps “E1, E2”.

During this third computation step “E3”, the value representing the absorption coefficient “α” is computed based on the following Beer-Lambert formula:

$$T = {e}^{\hat{}} ( - α \cdot 2 \cdot s ) .$$

where “T” represents the transmittance, “a” represents the absorption coefficient of the thermoplastic material and “s” represents the thickness of the wall 16. As will be explained hereafter, given that the transmittance “T” is measured by a light beam passing through the wall 16 twice, in this case the thickness “s” is multiplied by two.

As a variant, when the transmittance is measured through a single thickness of the wall 16, the factor of “2” before the thickness “s” is removed from all the formulae.

In this case, the invention proposes using a normalized transmittance “Tn” as a value representing the absorption coefficient “α”. Such a normalized transmittance “Tn” represents the transmittance that would be measured for a wall with a predetermined thickness “sn” made from the same material as the preform 12. The predetermined thickness “sn” is, for example, equal to 4 mm. Thus, by computing this normalized transmittance “Tn”, it is possible to compare the absorption properties of the material forming several preforms with different real thicknesses. This normalized transmittance “Tn” is computed using the following formula derived from the Beer-Lambert formula:

$$Tn = {T}^{\frac{sn}{2 s}}$$

where “Tn” represents the normalized transmittance, “T” represents the transmittance measured during the first step “E1”, “sn” represents the predetermined thickness, “s” represents the thickness measured during the second step “E2”.

As a variant, the value representing the absorption coefficient “α” is directly formed by the absorption coefficient “α”. In this case, the absorption coefficient “α” is computed by applying the following formula derived from the Beer-Lambert formula:

$$α = - \frac{1}{2 s} ln T$$

The computation step “E3” in this case is automatically implemented by an electronic control unit 54, notably shown in FIGS. 5, 7, 9 and 12.

The first step “E1” of measuring the value representing the transmittance “T” and the second step “E2” of measuring the thickness are carried out at the same height “h” on the wall 16 of the preform 12. The height “h” in this case is determined from a reference point, such as the free end of the neck 22, as is the case here, or the bearing surface 28 of the collar 26. With the wall 16 having a rotational shape about the “X” axis, this ensures that the transmittance “T” is measured on a portion of the wall 16 where the thickness corresponds to the thickness “s” measured during the second step “E2” of measuring the thickness.

Preferably, the thickness “s” and the transmittance “T” are measured at the same point on the wall 16 so that the value representing the absorption coefficient “α” is as precise as possible.

According to a first embodiment of the invention shown in FIG. 1, the measurement of the value representing the transmittance “T” and the measurement of the thickness “s” are successively carried out in a first measurement zone “Z1” and a second measurement zone “Z2” separate from the production path 34.

The first step “E1” of measuring the value representing the transmittance “T” and the second step “E2” of measuring the thickness “s” are thus carried out successively. For example, the first step “E1” is carried out before the second step “E2”, as shown in FIG. 3.

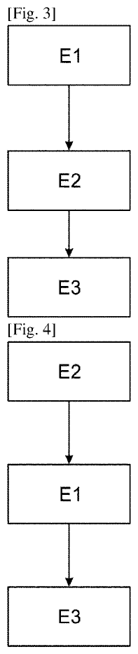

As a variant, the second step “E2” is carried out before the first step “E1”, as shown in FIG. 4.

The first step E1” of measuring the transmittance “T” in this case is carried out by measuring the attenuation of the intensity “I” of a first monochromatic light beam 55 with a predetermined first wavelength “λ1”. The first predetermined wavelength “λ1” is within the near infrared band. It preferably belongs to the range of higher intensity wavelengths of the heating electromagnetic radiation, in this case ranging between 800 nm and 1,600 nm.

To this end, the facility 10 comprises a device 56 for measuring the transmittance “T”. As shown in FIG. 5, this device 56 is arranged to measure the transmittance “T” of a preform 12 passing through the first measurement zone “Z1”.

The device 56 for measuring the transmittance “T” comprises a first light source 58 that emits the first monochromatic light beam 55 with the first wavelength “λ1”.

The first light source 58 comprises, for example, a light emitting diode (LED), a superluminescent diode (SLED) or a lamp. The first monochromatic light beam 55 is emitted perpendicular to the wall 16 of the preform 12. The first light beam 55 is emitted so as to pass through the preform 12 by passing through its main “X” axis.

The first light beam 55 is more specifically emitted along an axis that is perpendicular to a tangent to the production path 34 of the preform 12 in the first measurement zone “Z1”.

The first light beam 55 passes through the wall 16 at said height “h”.

The first light beam 55 can be guided in the correct direction by an optical guide means such as an optical fiber 60.

The device 56 for measuring the transmittance “T” further comprises a component 62 for measuring the intensity “I” of the first light beam 55 after it has passed through the wall 16 of the body 14 of the preform 12 at least once.

The component 62 for measuring intensity “I” in this case is arranged to measure the intensity “I” of the first light beam 55 on the other side of the preform 12 with respect to the “X” axis of the preform 12 after it has passed through the wall 16 twice at two diametrically opposite points, at the same height “h” on the preform 12.

In this configuration, it is preferable for the first predetermined wavelength “λ1” to be selected in a wavelength range whereby the thermoplastic material is transparent enough for the intensity “I” of the first light beam 55, after it has passed through the wall 16 twice, to be measured with sufficient precision and certainty by the measurement component. Indeed, the intensity “I” of the first light beam 55 would risk being too attenuated after two passes through the wall 16 if it was emitted at a wavelength that is easily absorbed by the thermoplastic material.

For example, in the case of a plastic material made of PET or rPET, the first wavelength “λ1” is within the ranges that range between 800 nm and 1,100 nm, or between 1,250 nm and 1,300 nm. The first wavelength “λ1” is selected, for example, from among the following values: 850 nm, 860 nm, 880 nm, 940 nm, 950 nm, 960 nm, 980 nm, 1,050 nm or 1,300 nm.

In a variant of the invention, not shown, the intensity measurement component is arranged so as to measure the intensity of the first light beam after it has passed through the wall of the preform once. In this case, the measurement component comprises a component for intercepting the light beam that is introduced into the preform during the first step, with the interception component guiding the intercepted light beam to an intensity measurement component.

The intensity measurement component 62 is, for example, a spectrometer that also allows the wavelength of the first monochromatic light beam 55 to be measured in order to reduce any risks of measurement errors due to spurious radiation.

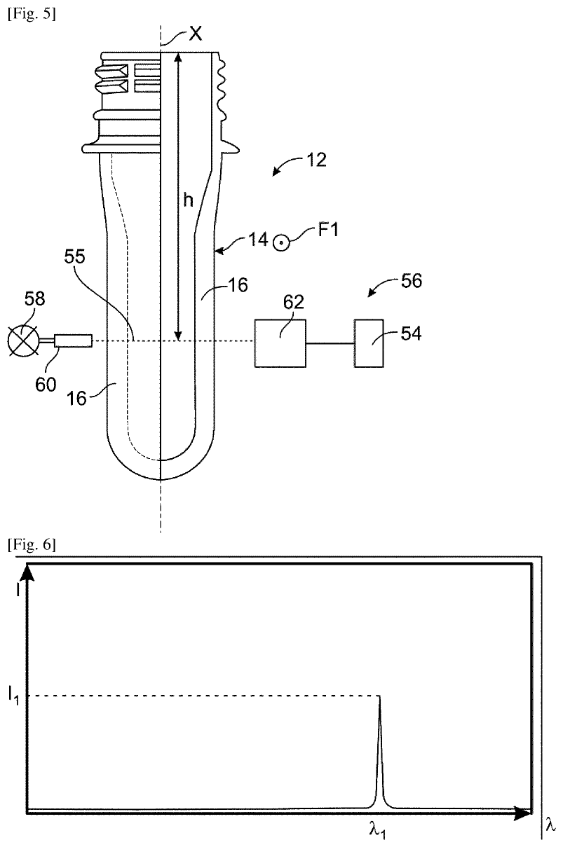

The measurement component 62 thus allows the measurement shown in FIG. 6 to be obtained.

The emission light intensity “I0” at which the first light beam 55 is emitted is known data. The light intensity “I0” at which the first light beam 55 is emitted also can be measured directly by the measurement component 62 when no preform 12 passes through the first measurement zone “Z1”.

After passing through the wall 16 of the preform 12 twice, the light intensity of the first light beam 55 is attenuated. The first light beam 55 then has a light intensity, called “transmitted light intensity “I1””.

Thus, it is easy to derive the transmittance “T” therefrom as a function of the ratio of the emission light intensity “I0” to the transmitted light intensity “I1”.

In order to more precisely compute the transmittance “T”, it is possible, but not compulsory, for this ratio to be weighted by taking into account the quantity of the first light beam 55 that is reflected each time it enters a wall 16. This reflected quantity is computed as a function of the reflectance factor “R”, which is a previously known quantity.

The weighting factor for the passage of the first light beam 55 through a wall thickness 16 is computed according to the following equation:

$${f}_{1} = \frac{{( 1 - R )}^{2}}{1 - {R}^{2}}$$

The weighting factor for the passage of the first light beam 55 through two wall thicknesses 16 is computed according to the following equation:

$${f}_{2} = \frac{{f}_{1}}{( 2 - {f}_{1} )}$$

The transmittance “T” when passing through two wall thicknesses 16 is thus computed by applying the following equation:

$$T = \frac{{I}_{1}}{{I}_{0}} \cdot {f}_{2}$$

The transmittance “T” is computed by the electronic control unit 54 that receives the measurements carried out by the measurement component 62.

The second step “E2” of measuring the thickness “s” in this case is carried out contactlessly using a thickness measurement device 64, which is an optical measurement device. As shown in FIG. 1, this thickness measurement device 64 is arranged to measure the thickness “s” of the wall 16 of a preform 12 passing through the second measurement zone “Z2”.

The thickness measurement device 64 comprises a second light source 66, separate from the first light source 58, that emits a second light beam 68 as a continuous spectrum in a predetermined wavelength range “λ2”. This wavelength range is delimited by a lower limit “λ2−min” and by an upper limit “λ2−max”.

The thickness “s” is then determined by analyzing a first portion of the second light beam 68 reflected by the outer face 18 and a second portion of the second light beam 68 reflected by the inner face 20 of the wall 16.

As shown in FIG. 7, the measurement of the thickness “s” of the wall is carried out, for example, by means of a device 64 for measuring the confocal thickness comprising the second light source 66 emitting the second continuous spectrum light beam 68.

The second light source 66 comprises, for example, a light emitting diode (LED), a superluminescent diode (SLED) or a lamp. The second continuous spectrum light beam 68 is emitted perpendicular to the wall 16 of the preform 12. The second light beam 68 is emitted so as to pass through the wall 16 by passing through its main X-axis.

The second light beam 68 is more specifically emitted along an axis perpendicular to a tangent to the path of the preform 12 in the second measurement zone “Z2”.

The second light beam 68 passes through the wall 16 at said height “h”.

The wavelength range “λ2” of the spectrum of the second light beam 68 extends, for example, in the visible band, i.e., the lower limit is “λ2−min” approximately equal to 380 nm and the upper limit “λ2−max” is approximately equal to 780 nm.

The second light source 66 comprises a continuous spectrum decomposition component 70, each component of which is focused in a plane orthogonal to the main “X” axis of the preform 12 and is at a determined distance from the decomposition component 70 as a function of its wavelength. Thus, each wavelength is focused at a determined axial distance from the decomposition component 70. The second light beam 68 thus decomposed passes through the wall 16 of the container 68.

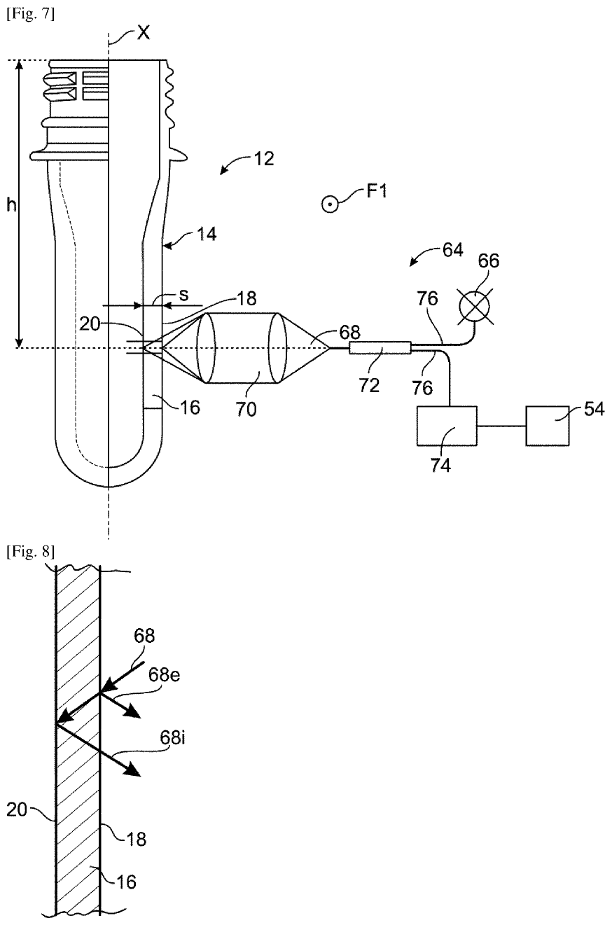

As shown in FIG. 8, in a known manner, the outer face 18 and the inner face 20 of the wall 16 of the preform 12 respectively reflect a first portion 68e and a second portion 68i of the second light beam 68 thus decomposed.

Each of said portions 68e, 68i can be identified by an intensity peak “I2−i, I2−e” at a determined wavelength “λ2−i, λ2−e”, as shown in FIG. 9. Each determined wavelength “λ2−i, λ2−e” corresponds to the wavelength of the component of the second light beam 68 that is respectively focused on the outer face 18 and the inner face 20 of the wall 16.

The thickness measurement device 64 further comprises a light beam splitting component 72 that is interposed on the path of the second light beam 68. The splitting component 72 allows the second light beam to pass through toward the preform 12 without deflecting it, while it redirects the reflected portions 68e, 68i of the reflected second light beam 68 toward a spectrometer 74 that measures the intensity “I” and the wavelength “λ” of the reflected portions 68e, 68i of the second light beam 68.

The splitting component 72 can be formed by an optical coupler, as is the case here, or by a semi-reflective mirror.

The second light beam 68 and/or the reflected portions 68e, 68i can be guided by guide means such as optical fibers 76.

Each reflected portion 68e, 68i of the second light beam 68 is substantially monochromatic. Thus, the first wavelength “λ2−e” shown in FIG. 9 corresponds to the portion 68e of the second light beam 68 reflected by the outer face 18 of the wall 16, while the second wavelength “λ2−i” shown in FIG. 8 corresponds to the portion 68i of the second light beam 68 reflected by the inner face 20 of the wall 16. This can be easily identified by the light intensity of each peak. Indeed, the portion 68e reflected by the outer face 18 has not passed through the wall and therefore has not been attenuated, while the portion 68i reflected by the inner face 20 has been attenuated by its round-trip in the wall 16.

Depending on the reflected wavelengths “λ2−i, λ2−e” and the refractive index “n” of the material forming the wall 16, the electronic control unit 54 computes the thickness “s” of the wall 16.

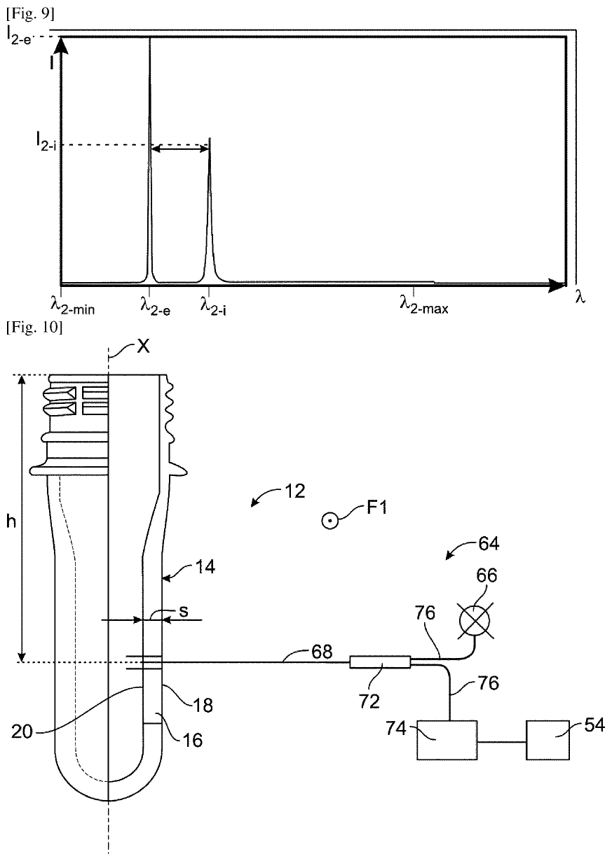

As a variant of the invention shown in FIG. 10, the thickness “s” of the wall 16 is measured by an interferometric thickness measurement device 64.

Such a thickness measurement device 64 comprises a second light source 66 that emits a second continuous spectrum light beam 68 in a predetermined wavelength range “λ2” perpendicular to the wall 16 of the preform 12. The second continuous spectrum light beam 68 is emitted perpendicular to the wall 16 of the preform 12. The second light beam 68 is emitted so as to pass through the wall 16 by passing through its main “X” axis.

The second light beam 68 is more specifically emitted along an axis perpendicular to a tangent to the path of the preform 12 in the second measurement zone “Z2”.

The second light beam 68 passes through the wall 16 at said height “h”.

The second light source 66 comprises, for example, a light emitting diode (LED), a superluminescent diode (SLED), or a lamp.

The spectrum of the second light beam 68 is selected so that it can pass through the wall 16 of the container 12.

The wavelength range “λ2” of the spectrum of the second light beam 68 extends, for example, in the near infrared band, for example, the lower limit “λ2−min” is approximately equal to 1,530 nm and the upper limit “λ2−max” is approximately equal to 1,570 nm.

Unlike the confocal measurement device, the radiation is not decomposed in this case.

When the second light beam 68 passes through the outer face 18 of the wall 16 of the container 12, a first portion 68e of the second light beam 68 is reflected by the outer face 18. The first reflected portion 68e has a continuous spectrum. It thus propagates in the axis of the second light beam 68 but in a reverse direction.

As a result, the second light beam 68 thus loses intensity “I” by continuing to travel through the wall 16. The spectrum of the first reflected portion 68e is the same as the spectrum of the second light beam 68, only the intensity “I” of the first reflected portion 68e is lower than that of the second light beam 68.

The second continuous light beam 68 is propagated inside the wall 16 of the container 12 until it reaches the inner face 20 of the wall 16. A second portion 68i of the second light beam 68 is reflected by the inner face 20. This second reflected portion 68i has a continuous spectrum. It thus propagates in the axis of the second light beam 68, but in a reverse direction. The spectrum of the second reflected portion 68i is identical to that of the second light beam 68.

The thickness measurement device 64 further comprises a light beam splitting component 72 that is interposed on the path of the second light beam 68. The splitting component 72 allows the second light beam 68 to pass through toward the preform 12 without deflecting it, while it redirects the reflected portions 68e, 68i of the second reflected light beam 68 toward a spectrometer 74 that measures the intensity “I” and the wavelength “λ” of the reflected portions 68e, 68i of the second light beam 68.

The splitting component 72 can be formed by an optical coupler, as is the case here, or by a semi-reflective mirror.

The second light beam 68 and/or the reflected portions 68e, 68i can be guided by guide means such as optical fibers 76.

The spectrometer 74 communicates with the electronic control unit 54.

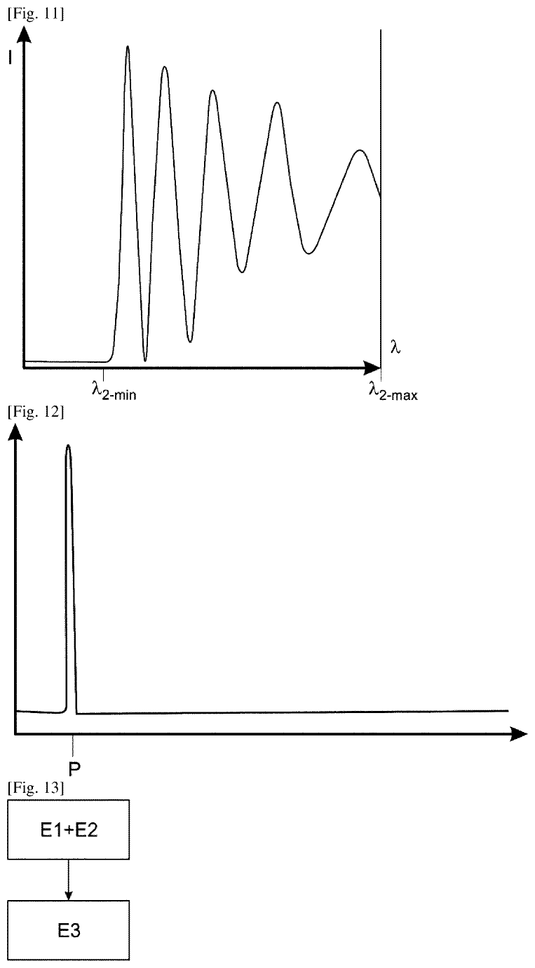

The first reflected portion 68e and the second reflected portion 68i of the second light beam 68 returning from the wall 16 interfere with each other in a generally known manner. This results in constructive or destructive interference depending on the difference in the path length of each of said reflected portions 68e, 68i caused by the thickness “s” of the wall 16, as shown in FIG. 11.

The interference produced by superimposing the first and second reflected portions 68e, 68i is analyzed by the spectrometer 74 and/or by the electronic control unit 54.

The first reflected 68e portion and the second reflected portion 68i have identical wave spectra but they are axially offset by a distance that is equal to the thickness “s” of the wall 16 of the container 12.

In a known manner, depending on the traversed thickness, the intensity “I” of some wavelengths of the superimposition of the reflected portions 68e, 68i will be reduced, while the intensity “I” of other wavelengths of said superimposition will be increased.

Thus, the wavelengths “λa” that verify the following equation, notably have a maximum intensity “I”:

$$s \times n = \frac{λa}{2} \times x$$

where “s” represents the thickness of the wall 16, “n” represents the refractive index of the material forming the wall 16 and “x” is any integer.

Indeed, the intensities “I” of the first reflected portion 68e and of the second reflected portion 68i add up to increase the intensity “I” of the radius for said wavelength “λa”.

However, the wavelengths “λb” that verify the following equation, have a minimum intensity “I”:

$$s \times n = \frac{λ b}{2} \times ( x + 0 , 5 )$$

where “s” represents the thickness of the wall 16, “n” represents the refractive index of the material forming the wall 16 and “x” is any integer.

Indeed, the intensities “I” of the first reflected portion 68e and of the second reflected portion 68i are subtracted in order to decrease the intensity “I” of the radius for said wavelength “λb”.

The interference thus results in a beat phenomenon. The beat phenomenon is a periodic variation of the light intensity “I” of the superimposition of the two reflected portions 68e, 68i as a function of the frequency “1/λ” of the light wave, as illustrated in FIG. 10.

By using a Fourier transform, which is an operation that is well known to a person skilled in the art, it is easy to find the period “P” of this periodic variation, as shown in FIG. 12. This period “P” is proportional to the optical thickness, which is equal to the product of the thickness “s” of the wall 16 of the container 12 by the refractive index “n” of the material forming said wall 16. It is thus possible to find the thickness “s” of the wall 16 of the container 12 by knowing the refractive index “n” of the material or by calibrating the measurement on a test wall whose thickness has been measured by other known means.

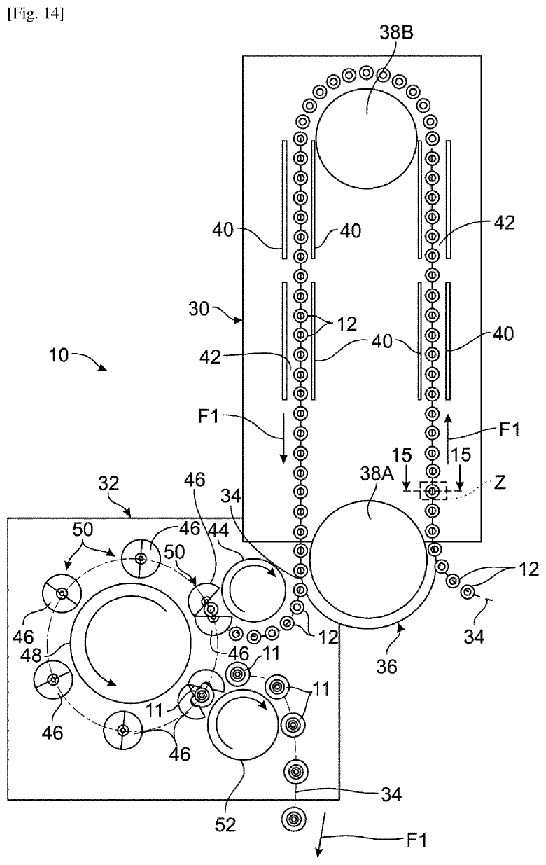

According to a second embodiment of the invention shown in FIG. 13, the step “E1” of measuring the value representing the transmittance “T” and the step “E2” of measuring the thickness “s” are carried out simultaneously. In this case, the measurement of the transmittance “T” and the measurement of the thickness “s” are carried out simultaneously in a common measurement zone “Z” of the production path 34, as shown in FIG. 14.

To this end, the transmittance measurement device 56 and the thickness measurement device 64 in this case are arranged in the common measurement zone “Z”, as shown in FIG. 15.

The transmittance measurement device 56 operates in a similar manner to that described in the first embodiment and it has substantially the same structure. Only the structural and operating differences will be described hereafter.

Similarly, the thickness measurement device 64 operates in a similar manner to the description provided in the first embodiment and it has substantially the same structure. As in the first embodiment, it can be a confocal measurement device or an interferometric measurement device. Only the structural and operating differences will be described hereafter.

FIG. 15 shows an embodiment in which the thickness measurement device 64 is a confocal measurement device comprising a component 70 for decomposing the second light beam 68.

As a variant, not shown, the thickness measurement device is an interferometric measurement device with a structure identical to that shown in FIG. 15, except for the decomposition component, which can be removed.

The first light source 58 and the second light source 66 respectively emit the first light beam 55 and the second light beam 68 to the common measurement zone “Z” of the production path 34 in order to simultaneously touch the preform 12 passing through said measurement zone “Z”.

The first light beam 55 and the second light beam 68 are emitted co-axially. The first light source 58 and the second light source 68 are arranged on either side of the production path 34 so that the first light beam 55 enters the body 14 of the preform via one side, while the second light beam 68 enters the preform 12 via a diametrically opposite side.

The first light beam 55 and the second light beam 68 are emitted perpendicular to the wall 16 of the preform 12 so as to pass through the wall 16 by passing through its main “X” axis.

The first light beam 55 and the second light beam 68 are more specifically emitted along an axis perpendicular to a tangent to the path of the preform 12 in the common measurement zone “Z”.

The first light beam 55 and the second light beam 68 pass through the wall 16 at said height “h”.

The component 62 for measuring the intensity of the first light beam 55 after it passes through at least one thickness of the wall 16 in this case is formed by the spectrometer 74 of the thickness measurement device 64. The transmittance measurement device 56 and the thickness measurement device 64 thus include a single common spectrometer 74. This advantageously allows the manufacturing cost of the facility 10 to be reduced.

This configuration is possible due to the fact that the first light beam 55 and the second light beam 68 are coaxial and in opposite directions. Indeed, the first beam 55, after it has passed through the two wall thicknesses 16, exits the preform 12 in the axis of the splitting component 72, which thus collects this first light beam 55 transmitted toward the spectrometer 74.

Furthermore, in order to enable this configuration, it is preferable for the first wavelength “λ1” of the first monochromatic light beam 55 to be outside the wavelength range “λ2” of the second light beam 68.

In order to avoid any measurement errors, it is preferable for it to remain at a free interval 80 between the first wavelength “λ1” of the first monochromatic light beam 55 and the limit “λ2−min” or “λ2−max” closest to the wavelength range “λ2” of the second light beam 68.

This is the case here, since the first wavelength “λ1” is within the ranges that range between 800 nm and 1,100 nm, or between 1,250 nm and 1,300 nm, while the wavelength range “λ2” of the continuous spectrum of the second light beam 68 extends between 380 nm and 780 nm, in the case of a confocal measurement device, or between 1,530 nm and 1,570 nm, in the case of an interferometric measurement device.

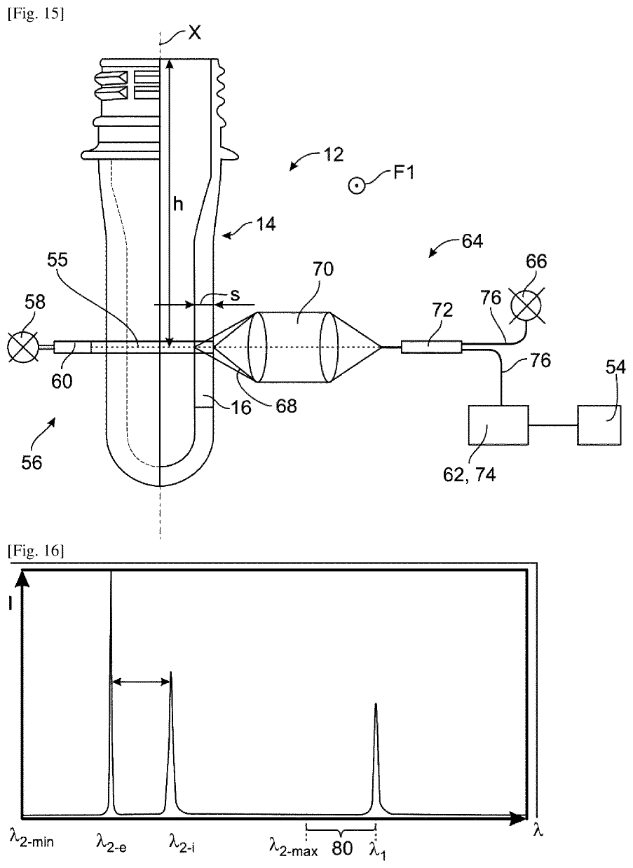

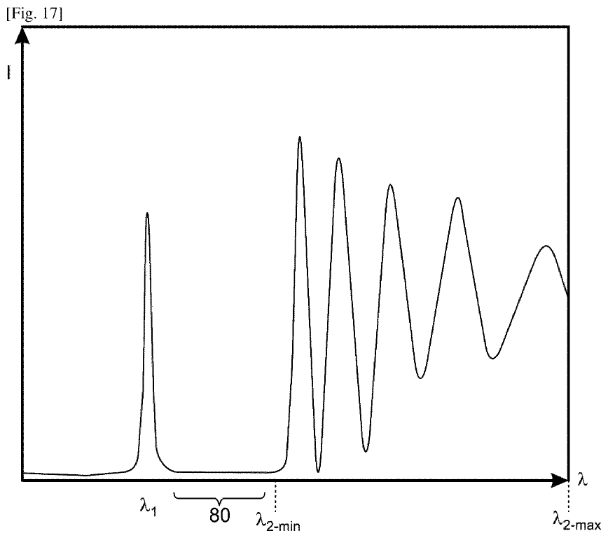

The spectrometer 74 and/or the electronic control unit 54 can thus clearly identify the measured values that correspond to the first light beam 55 and the measured values that correspond to the reflected portions 68e, 68i of the second light beam 68 based on the measured wavelength values, as shown in FIG. 16, in the case of a confocal measurement device, or FIG. 17 in the case of an interferometric measurement device.

Thus, the isolated peak corresponding to the first wavelength “λl” corresponds to the value used to measure the transmittance “T”, while the intensities measured in the wavelength range “λ2” of the spectrum of the second light beam 68 correspond to the values used to measure the thickness “s” of the wall 16.

Irrespective of the embodiment of the method for determining a value representing the implemented absorption coefficient “α”, the method is repeated in this case for each preform passing through the one or more measurement zones “Z, Z1, Z2”.

It is thus possible to compare the values representing the absorption coefficient “α” for all the preforms 12 of the same batch. With this value being independent of the actual thickness of each preform 12, it is possible to quickly know whether a production defect in some containers 11 is due to the quality of the material forming the preforms 12 or if it is another defect.

Furthermore, it is possible to store the values obtained for each of the preforms 12 in order to compare them to values obtained for other batches of preforms 12.

As a variant, the method is only carried out on a sample of preforms 12 from the same batch, for example, the method is repeated for a preform 12 over a determined number of preforms 12, for example, one preform in two or one preform in three.

1. A method for determining a value representing an absorption coefficient of a thermoplastic material forming a preform, when the preform is conveyed along a predetermined production path in a facility for manufacturing containers by shaping preforms, the method comprising:
a step of measuring a value representing a transmittance of infrared radiation through at least one wall of the preform during the preform's movement along the path; and
a step of measuring a thickness of said wall of said preform during the movement along the path;
a step of computing a value representing the absorption coefficient of the thermoplastic material independent of the thickness of the preform based on said measurement of the value representing the transmittance and said measurement of the thickness.

2. The method as claimed in claim 1, wherein the measurement of the value representing the transmittance and the measurement of the thickness are carried out at a same height on the wall of the preform.

3. The method as claimed in claim 2, wherein the measurement of the value representing the transmittance and the measurement of the thickness are carried out at a same point on the wall of the preform.

4. The method as claimed in claim 1, wherein the measurement of the value representing the transmittance and the measurement of the thickness are successively carried out in two distinct measurement zones of the production path.

5. The method as claimed in claim 1, wherein the measurement of the value representing the transmittance and the measurement of the thickness are simultaneously carried out in a same measurement zone of the production path.

6. The method as claimed claim 1, wherein the measurement of the value representing the transmittance is carried out by measuring an attenuation of an intensity of a first monochromatic light beam after the first monochromatic light beam passes through at least one wall of the preform, with the first monochromatic light beam having a first predetermined wavelength and being emitted perpendicular to the wall of the preform.

7. The method as claimed in claim 6, wherein the first predetermined wavelength is within a near infrared band.

8. The method as claimed in claim 1, wherein the measurement of the thickness of the wall is carried out by a confocal measurement device that emits a second continuous spectrum light beam in a predetermined wavelength range.

9. The method as claimed claim 1, wherein the measurement of the thickness of the wall is carried out by an interferometric measurement device that emits a second continuous spectrum light beam in a predetermined wavelength range.

10. The method as claimed in claim 8, wherein the first wavelength of the first monochromatic light beam is outside the wavelength range of the second continuous spectrum light beam.

11. The method as claimed claim 1, wherein the method is repeated for each preform passing through one or more measurement zones.

12. A facility for implementing t method for determining a value representing an absorption coefficient of a thermoplastic material forming a preform, the facility comprising means for conveying preforms in a line along a predetermined production path successively passing through a zone for heating a body of the preforms and through a station for shaping preforms into a container by stretch-blowing, the facility comprising:
a device for measuring a value representing the transmittance of at least one wall of the preforms when the preforms pass through an associated measurement zone; and
a device for measuring the thickness of the wall of the preforms when the preforms pass through an associated measurement zone.

13. The facility as claimed in claim 12, wherein the device for measuring the value representing the transmittance comprises a first light source that emits a first light beam having a first wavelength, and the device for measuring thickness comprises a second light source, distinct from the first light source, wherein the second light source emits a second light beam as a continuous spectrum in a predetermined wavelength range.

14. The facility as claimed in claim 13, wherein the first light beam and the second light beam pass through the wall of the preform at a same height.

15. The facility as claimed in claim 12, wherein the first light beam and the second light beam pass through the wall of the preform at a same point.

16. The facility as claimed in claim 13, wherein the measurement of the value representing the transmittance and the measurement of the thickness are successively carried out in two distinct measurement zones of the production path, and wherein the first light beam and the second light beam pass through the wall of the preform at a same height or at a same point.

17. The facility as claimed in claim 13, wherein the measurement of the value representing the transmittance and the measurement of the thickness are carried out simultaneously in a same measurement zone of the production path, and wherein the first light beam and the second light beam pass through the wall of the preform at a same height or at a same point.

18. The facility as claimed in claim 17, wherein the first light source and the second light source are arranged on either side of the production path so as to emit the first light beam and the second light beam coaxially to each other.

19. The facility as claimed in 13, wherein the first light beam and the second light beam pass through the wall of the preform at a same height, and wherein the thickness measurement device comprises a spectrometer measuring the intensity and the wavelength of two portions of the second light beam respectively reflected by an outer face and by an inner face of the wall of the preform.

20. The facility as claimed in any one of claims 14 to 19, wherein the device for measuring a value representing the transmittance comprises a component for measuring the intensity of the first light beam after it has passed through at least one wall of the preform.

21-23. (canceled)
